(19) United States
(12) Patent Application Publication
(10) Pub. No.: US 2014/0061391 A1
(43) Pub. Date: Mar. 6, 2014

(54) TWO-STROKE, FUEL INJECTED INTERNAL COMBUSTION ENGINES FOR UNMANNED AIRCRAFT AND ASSOCIATED SYSTEMS AND METHODS

(71) Applicants: Paul Ffield, The Dalles, OR (US); Charles H. Simmons, JR., Seattle, WA (US); Glen Stebbins, Mosier, OR (US)

(72) Inventors: Paul Ffield, The Dalles, OR (US); Charles H. Simmons, JR., Seattle, WA (US); Glen Stebbins, Mosier, OR (US)

(73) Assignee: Insitu, Inc., Bingen, WA (US)

(21) Appl. No.: 13/565,427

(22) Filed: Aug. 2, 2012

Related U.S. Application Data
(63) Continuation of application No. PCT/US2011/023815, filed on Feb. 4, 2011.
(60) Provisional application No. 61/302,034, filed on Feb. 5, 2010.

(51) Int. Cl. F02M 39/00; B64D 27/08

(52) U.S. Cl. CPC F02M 39/00; B64D 27/08
USPC 244/53 R; 123/457

(57) ABSTRACT

Two-stroke, fuel injected internal combustion engines for unmanned aircraft and associated systems and methods are disclosed herein. Engines configured in accordance with embodiments of the disclosure can include, for example, (a) an electronic fuel injection system configured to provide a desired low fuel rate by injecting fuel every nth compression cycle rather than every cycle (so-called “skip-cycle” operation), (b) one or more pressure sensors configured to measure fluctuations in peak crankcase pressure and use such fluctuations to control fuel injection delivery, and (c) a multi-cylinder configuration having a common crankcase with a fuel injection arrangement configured to mitigate or eliminate problems with mixed redistribution.

### REFERENCE TO RELATED APPLICATION

The present application is a continuation of International Patent Application No. PCT/US2011/023815, filed Feb. 4, 2011, which claims the benefit of U.S. Provisional Patent Application No. 61/302,034, filed Feb. 5, 2010, each of which is incorporated herein by reference in its entirety.

### TECHNICAL FIELD

The present disclosure is directed generally to two-stroke, fuel injected internal combustion engines for unmanned aircraft and associated systems and methods.

### BACKGROUND

Unmanned aircraft or air vehicles (UAVs) provide enhanced and economical access to areas where manned flight operations are unacceptably costly and/or dangerous. For example, unmanned aircraft outfitted with remotely operated movable cameras can perform a wide variety of surveillance missions, including spotting schools of fish for the fisheries industry, monitoring weather conditions, providing border patrols for national governments, and providing military surveillance before, during, and/or after military operations.

Many unmanned aircraft are powered by two-stroke internal combustion engines. Such engines are also widely utilized in small handheld devices or tools (e.g., chain saws, leaf blowers, weed trimmers; etc.) and a variety of different types of vehicles (e.g., jet skis, snowmobiles, motorcycles, etc.). One feature of a typical two-stroke engine is that the engine fires once every revolution. This gives two-stroke engines a significant power boost as compared to four-stroke engines that fire once every other revolution, and gives two-stroke engines an improved power-to-weight ratio as compared to many four-stroke engines. Another feature of two-stroke engines is that the engines can work in any orientation. This feature can be important, for example, in unmanned aircraft that operate in a variety of different operating conditions and orientations. In contrast, a standard four-stroke engine may have problems with oil flow unless it is generally upright during operation. Moreover, solving this problem in four-stroke engines can add complexity and additional weight to the engines. Yet another feature of two-stroke engines is that such engines generally have a simplified construction with fewer components and, accordingly, less weight than many four-stroke engine configurations with similar power output.

Fuel injection systems are becoming widely utilized in two-stroke engines to increase fuel economy and engine performance. Fuel injection systems, for example, can provide an operator with precise control over the air and fuel mixture in two-stroke engines and significantly improve the performance of such engines, while allowing the engines to meet increasingly stringent emission standards. One drawback associated with fuel injection systems, however, is the added cost and complexity associated with implementation of such systems in two-stroke engines. Furthermore, fuel injections systems typically require a significant amount of electrical power for operation. Accordingly, while operating unmanned aircraft with fuel injected two-stroke engines provides a number of advantages associated with improved fuel economy, performance, and reduced emissions, there is a continual need to improve the effectiveness and efficiency of such engines.

### BRIEF DESCRIPTION OF THE DRAWINGS

FIG. 1 is a partially schematic, isometric illustration of an unmanned aircraft having a two-stroke, fuel injected internal combustion engine configured in accordance with several embodiments of the disclosure.

FIG. 2 is a schematic illustration of the two-stroke fuel injected engine of FIG. 1 before installation with the aircraft.

FIG. 3 is a graphical illustration of a fuel/air equivalence ratio during operation of the engine of FIG. 2 in accordance with an embodiment of the disclosure.

FIGS. 4A-4D are schematic illustrations of a two-stroke fuel injected engine configured in accordance with another embodiment of the disclosure.

FIG. 5 is a schematic illustration of a two-stroke fuel injected engine configured in accordance with yet another embodiment of the disclosure.

### DETAILED DESCRIPTION

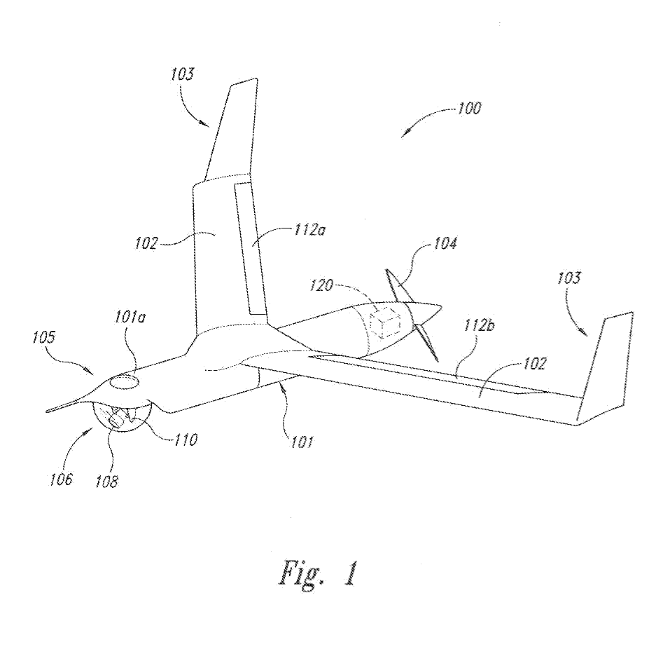

The present disclosure describes two-stroke, fuel injected internal combustion engines for unmanned aircraft and associated systems and methods. Many specific details of certain embodiments of the disclosure are set forth in the following description and in FIGS. 1-5 to provide a thorough understanding of these embodiments. Well-known structures, systems, and methods often associated with such systems have not been shown or described in detail to avoid unnecessarily obscuring the description of the various embodiments of the disclosure. In addition, those of ordinary skill in the relevant art will understand that additional embodiments may be practiced without several of the details described below.

FIG. 1 is a partially schematic, isometric illustration of an unmanned aircraft 100 including a two-stroke, fuel injected internal combustion engine 120 (shown schematically) configured in accordance with several embodiments of the disclosure. The unmanned aircraft 100 can include a fuselage 101 and a pair of wings 102 extending outwardly from the fuselage 101. Each wing 102 can include an upwardly extending winglet 103 for lateral stability and control. The aircraft 100 can also include one or more movable control surfaces (two ailerons 112a and 112b are shown in the illustrated embodiment). Although the ailerons 112a and 112b are the only control surfaces shown in FIG. 1, it will be appreciated that the aircraft 100 can include multiple aerodynamic control surfaces (e.g., rudder(s), elevators, stabilizers, ailerons, trailing and/or leading edge flaps, cowling flaps, attenuators, trim tabs, control tabs, speed brakes, etc.). A nose portion 105 of the fuselage 101 can include a turret assembly 106 having a device 108 (e.g., an imaging device, camera, surveillance sensor, or other payload) carried by a gimbal system 110 (shown schematically).

The aircraft 100 also includes a propeller 104 operably coupled to the engine 120. The propeller 104 is positioned at the aft end of the fuselage 101 to propel the aircraft 100 during flight. In other embodiments, the propeller 104 and/or the engine 120 may have a different arrangement on the aircraft 100 and/or relative to each other. The aircraft 100 may also include a number of other mechanisms, assemblies, or systems operably coupled to the engine 120.

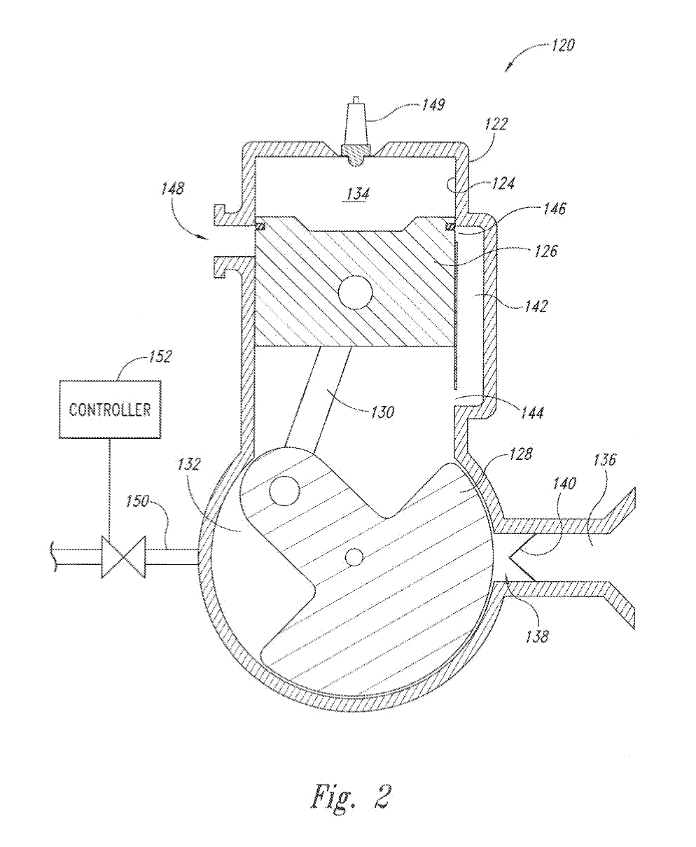

As described in detail below, embodiments of the engine 120 can include, for example, (a) an electronic fuel injection system configured to provide a desired low fuel rate by injecting fuel every nth compression cycle rather than every cycle (so-called “skip-cycle” operation), (b) one or more pressure sensors configured to measure fluctuations in peak crankcase pressure and use such fluctuations to control fuel injection delivery, and (c) a multi-cylinder configuration having a common crankcase with a fuel injection arrangement configured to mitigate or eliminate problems with mixed redistribution. Compared with conventional two-stroke engines, embodiments of the engine 120 are expected to provide improved engine and aircraft performance, better fuel economy, lower manufacturing costs, and greater overall efficiency in operation. It will be appreciated that an engine configured in accordance with this disclosure may include only one of the foregoing features, or may include two or more of the features in combination. Further details regarding the engine 120 and associated systems and methods are described below with reference to FIGS. 2-5.

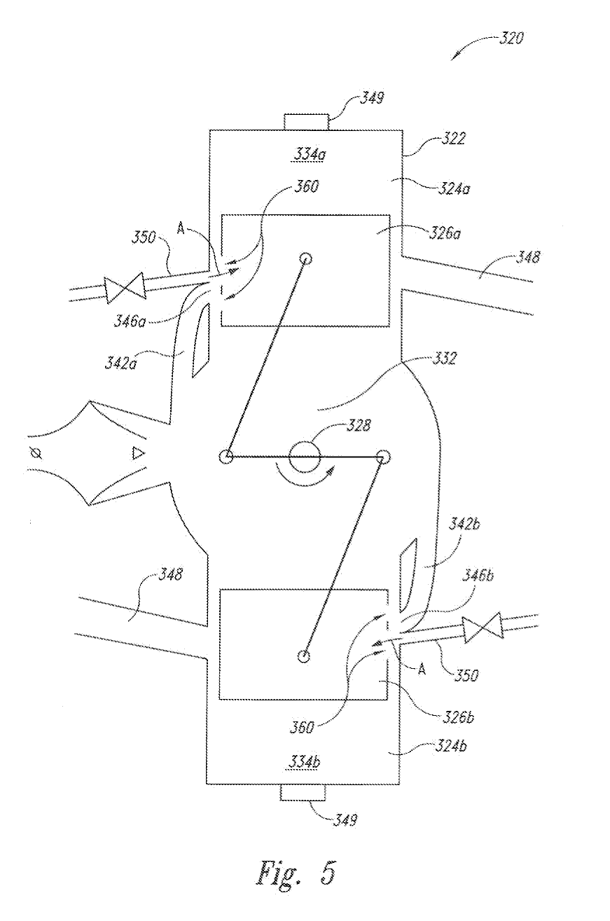

FIG. 2 is a schematic illustration of the two-stroke fuel injected engine 120 before installation with the aircraft 100 (FIG. 1). In the embodiment illustrated in FIG. 2, only a single cylinder of the engine 120 is shown. It will be appreciated, however, that the engine 120 may have one or more additional cylinders (see, e.g., FIG. 5 described below). For purposes of illustration, a number of components of the engine 120 are not shown or described. Furthermore, the sizes and relative positions of the elements in FIG. 2 and the other drawings in the disclosure are not necessarily drawn to scale, and certain elements, may be arbitrarily enlarged and positioned to improve drawing legibility.

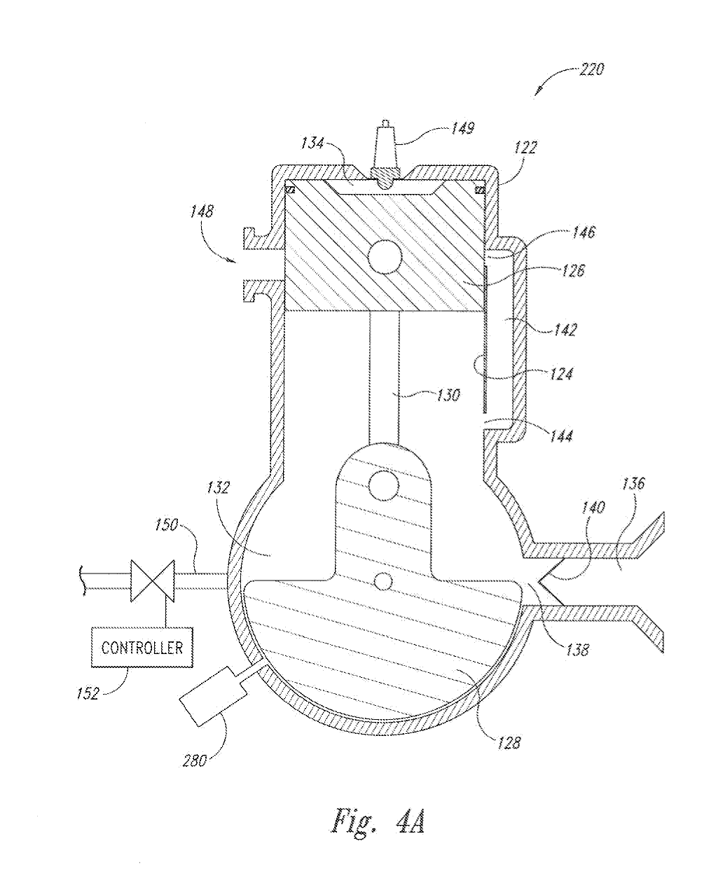

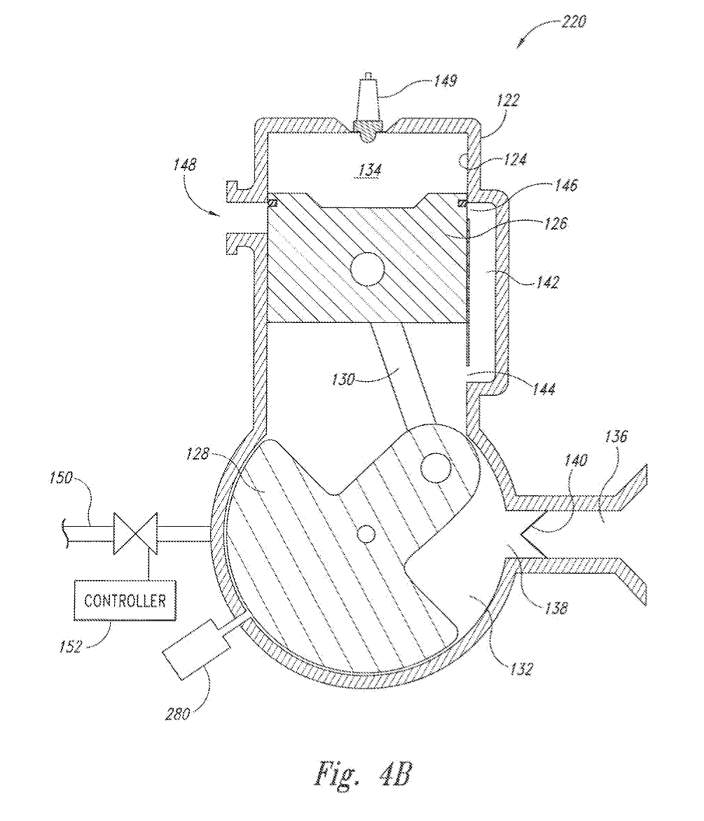

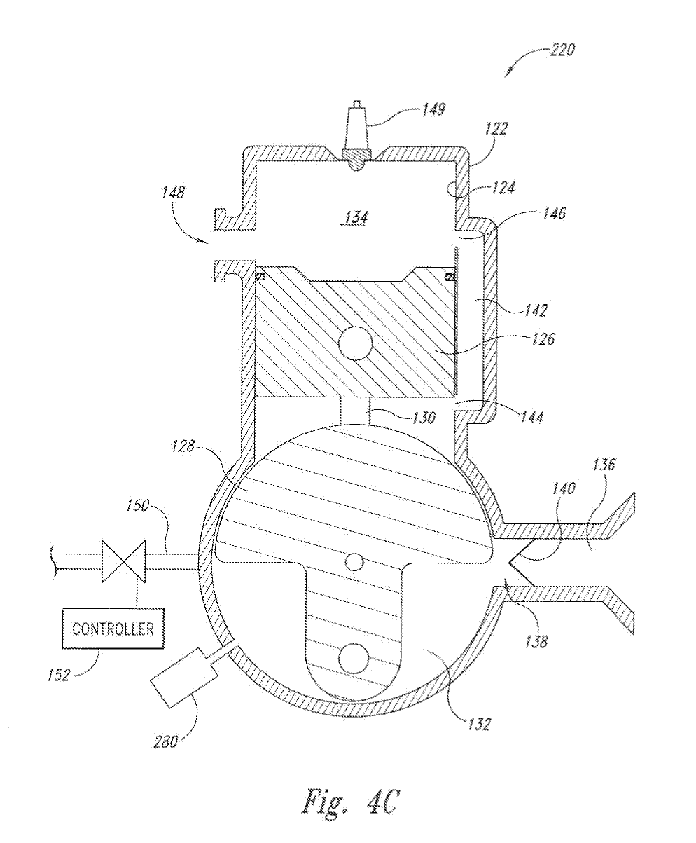

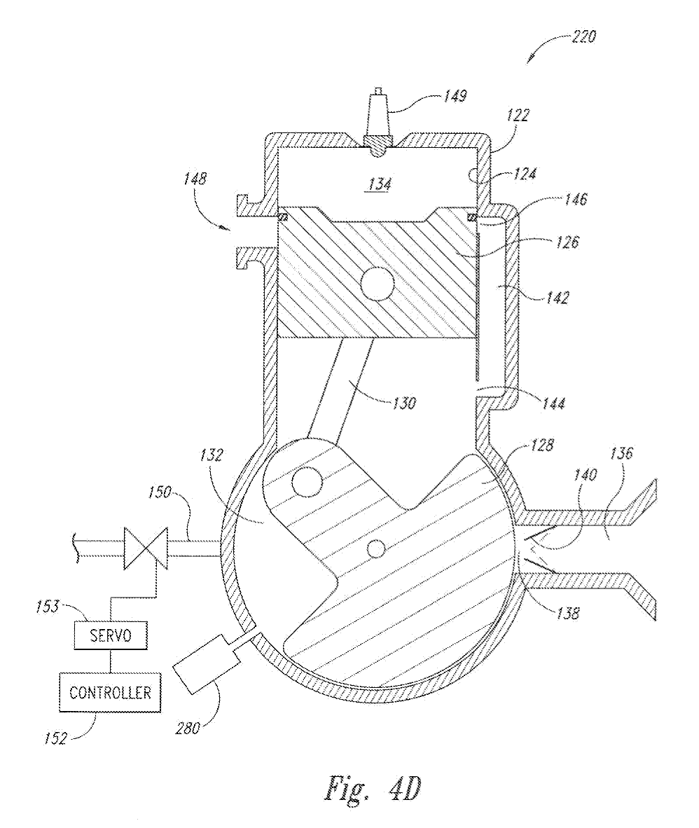

The engine 120 includes a cylinder block 122 having a cylinder bore 124 formed therein. The engine 120 also includes a piston 126 slidably housed in the cylinder bore 124 and connected to a crankshaft 128 via a connecting rod 130. The piston 126 is configured to reciprocably move relative to the cylinder bore 124 as the crankshaft 128 rotates within a crankcase 132. The piston 126 and the cylinder bore 124 together define a variable volume combustion chamber 134. A transfer or scavenge passage 142 extends through the cylinder block 122 between the crankcase 132 and the combustion chamber 134. More specifically, the transfer passage 142 has a first end 144 in communication with the crankcase 132 and a second end or transfer port 146 positioned to be opened and, closed relative to the combustion chamber 134 as the piston 126 slidably moves within the cylinder bore 124 between a top dead center position (see FIG. 4A) and a bottom dead center position (see FIG. 4C). The engine 120 is,a heavy fuel engine (HFE) configured to use kerosene-based heavy fuels (e.g., JP-5, JP-8, Jet-A, D-2 diesel). It will be appreciated, however, that the disclosure is not limited to HFEs, and the various embodiments described herein may be used with gasoline-powered two-stroke engines in addition to HFEs.

The engine 120 also includes an air induction system comprising an air intake track or passage 136 having an inlet portion 138 in fluid communication with crankcase 132. One or more check valves 140 (e.g., reed type or rotary check valves) are positioned at the inlet portion 138 of the air intake passage 136 and configured to prevent undesirable reverse flow. An exhaust system comprising an exhaust passage 148 is in communication with the combustion chamber 124 and configured to exhaust gases to the atmosphere. The engine 120 also includes one or more ignition sources (e.g., spark plugs) 149 carried by a cylinder head and configured to fire a charge in the combustion chamber 134.

The engine 120 further includes a fuel injector 150 configured to supply fuel to the crankcase 132. In one embodiment, the fuel injector 150 can be configured for indirect injection of the fuel and a solenoid valve (not shown) can be used to help control the flow rate of fuel from the intake track into the crankcase 132. In other embodiments, however, the fuel injector 150 can be configured to directly inject fuel into the crankcase 132. In still other embodiments, the fuel injector 150 can have a different arrangement.

A fuel injection system controller 152 is operably coupled to the fuel injector 150 and configured to control operation of the fuel injector 150. The controller 152, for example, can be configured to receive information from the aircraft 100 (FIG. 1) and the engine 120 and optimize engine performance based on such information. In the illustrated embodiment, for example, fuel delivery (i.e., an injection event) is controlled by a map schedule (not shown) stored in the controller 152 (e.g., in non-volatile memory) in which the controller 152 optimizes engine performance utilizing sensor data (e.g., temperature, crankcase pressure, throttle position, crank timing, etc.) and skip-cycle techniques. In particular, the controller 152 is configured to vary the injection event based on the map schedule such that the injection event occurs every nth compression cycle of the engine 120 rather than every cycle.

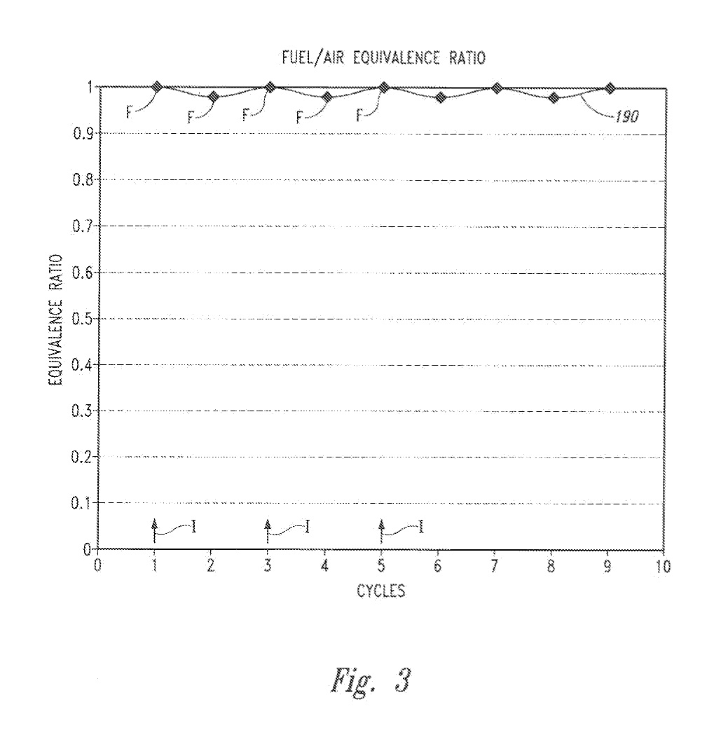

Without being bound by theory, the present inventors have discovered that introducing fuel into the engine 120 every nth cycle results in significant fuel savings without any appreciable loss in the fuel to air equivalence ratio or engine power. FIG. 3, for example, is a graphical illustration of a fuel/air equivalence ratio 190 during skip-cycle operation of the engine 120 in accordance with an embodiment of the disclosure. As shown in FIG. 3, combustion or firing events F occur every cycle of the engine 120 (e.g., when the piston 126 (FIG. 2) is at top dead center). Injection events I, however, occur only every other cycle (e.g., cycle 1, cycle 3, cycle 5, etc.). As the graph illustrates, injecting only on odd-numbered cycles does not significantly affect the fuel/air equivalence ratio 190. More specifically, because the volume of the crankcase 132 (FIG. 2) is much larger than the volume of the combustion chamber 134 (FIG. 2), the fuel/air equivalence ratio 190 stays approximately the same during skip-cycle operation. In the illustrated embodiment, all the injection events are synchronous with the engine 120. In other embodiments, however, the injection events or pulses do not have to be synchronous. In still other embodiments, the injection events can occur every third cycle, every fourth cycle, etc. For example, the timing of the injection events as related to the combustion events can be adjusted based upon the particular engine configuration and/or the operating requirements for the aircraft.

Referring back to FIG. 2, one feature of the engine 120 is that the skip-cycle techniques described herein allow the engine 120 to use a much larger fuel injector 150 than would typically be used. Larger fuel injectors are typically not used in small displacement engines, such as the engine 120, because the flow rate of such injectors is too high for the size of the engine. This problem is further magnified when the aircraft is operated at low speeds. The skip-cycle techniques described herein, however, enable the engine 120 to effectively utilize a larger size fuel injector 150 than conventional small displacement engines. This feature is expected to significantly reduce the costs associated with production and maintenance of the engine 120 without impacting performance. Another feature of the engine 120 is that utilizing the above-described skip-cycle techniques is expected to provide an approximately 10% improvement in fuel economy as compared with standard fuel injected two-stroke engines. Moreover, the engine 120 is expected to have consistently lower brake specific fuel consumption (BSFC) over a wider RPM band than conventional systems.

Still another feature of the engine 120 is that the skip-cycle techniques described herein are expected to significantly reduce electrical consumption for the aircraft 100 (FIG. 1). In many unmanned aircraft, for example, the fuel injector 150 can be responsible for up to 90% of the total power required for operation of the electronic fuel injection system. Because the fuel injector 150 in the engine 120 does not have to fire on every cycle, the fuel injection system of the engine 120 is expected to use approximately ½ to ⅔ less power than that of conventional fuel injection systems.

FIGS. 4A-4D are schematic illustrations of a two-stroke fuel injected engine 220 configured in accordance with another embodiment of the disclosure. More specifically, FIGS. 4A-4D illustrate the engine 220 at various points within a cycle of the engine 220. The engine 220 differs from the engine 120 described above in that the engine 220 comprises one or more pressure sensors 280 configured to measure fluctuations in peak crankcase pressure and use such fluctuations to control fuel delivery via the fuel injection system. The engine 220 can function in generally the same way as the engine 120 described above with reference to FIGS. 1-3 and can have many of the same features and advantages. For example, the engine 220 may also be configured to utilize the skip-cycle techniques described above as well as various other features described herein.

Referring first to FIG. 4A, the pressure sensor 280 comprises a pressure transducer positioned adjacent to and in communication with the crankcase 132. The arrangement of the pressure sensor 280 in the illustrated embodiment is merely representative of one specific configuration, and it will be appreciated that the pressure sensor 280 can be positioned at a number of different locations in the crankcase 132. Furthermore, although only a single pressure sensor 280 is shown, one or more additional pressure sensors 280 may be used. The pressure sensor 280 can include a variety of different suitable pressure sensing devices known to those of ordinary skill in the art.

In the arrangement shown in FIG. 4A, the piston 126 is at top dead center (TDC) and the ignition source 149 fires to ignite the compressed air/fuel mixture in the combustion chamber 134. Referring next to FIG. 4B, the piston 126 starts downward under pressure from the combustion event in the combustion chamber 134. This downward movement or down stroke causes the mixture in the crankcase 132 to be compressed and the pressure in the crankcase 132 to increase. The pressure (as measured by the pressure sensor 280) peaks just before the piston 126 uncovers the transfer port 146 and moves to bottom dead center (BDC), as shown in FIG. 4C. The peak pressure can vary depending on load for a given RPM due to, among other things, changes in the air intake track or passage 136. For example, as additional load is put on the engine 220 for a given RPM, additional air/fuel will be required and the air intake track 136 will be farther open. This allows more air under the piston 126 and results in a higher pressure spike as the piston 126 moves downward during the down stroke. Referring to FIG. 4D, the piston 126 starts a compression or up stroke. A fresh fuel/air mixture is drawn into the crankcase 132 via the one or more valves 140 by a vacuum that is created during the upward stroke of the piston 126.

Data from the pressure sensor 280 is processed and sent to the fuel injection system controller 152. The controller 152 is configured to use the peak pressure data in conjunction with a fuel map, lookup table, or other suitable data analysis technique to control fuel delivery to the engine 220. More specifically, the controller 152 is configured to determine load based on data from the pressure sensor 280 and control one or more parameter of the injection event or pulse based on this data.

Many conventional four-stroke engines sense vacuum or “valley pressure” in the air intake track or passage of the engine to control and/or adjust the fuel injection system for the engine. One challenge in many conventional two-stroke engines, however, is that there is very little pressure fluctuation in the intake track (e.g., the air intake track 136). The present inventors have discovered, however, that by sensing the peak positive pressure in the crankcase 132 with the pressure sensor 280, the engine 220 can have the same type of control as many four-stroke engines because, as discussed above, the peak pressure in the engine 220 varies and changes slightly with differing loads at different RPMs.

One feature of the two-stroke engine 220 is that the engine 220 can utilize speed density control mode. As is known to those of ordinary skill in the art, speed density mode comprises monitoring a number of engine operating parameters (e.g., engine RPM, intake manifold pressure (or vacuum), intake charge air temperature, etc.). Based on these real-time inputs and predetermined operating parameter values, an electronic engine control (ECC) module (not shown) calculates the volume of air coming into the engine 220 at any given time. The ECC then calculates the appropriate amount of fuel needed to operate the engine 220 at the air/fuel ratio specified in a target air/fuel ratio table or map. Speed density mode is expected to provide the engine 220 with a high degree of tunability for different engine loads, weather conditions, altitudes, etc. because all of these calculations happen in real time during operation.

Another feature of the engine 220 is that using peak pressure to control fuel delivery via the fuel injection system provides a means of either primary control or secondary, backup control of the fuel injection system 150 in the event of one or more sensor failures. For example, the pressure sensor 280 configured to measure the peak pressure in the crankcase 132 can provide a backup for the current sensors (e.g., piston position sensors, throttle position sensors, Hall Effect sensors, etc.). Still another feature of the engine 220 is that measuring the peak positive pressure with the pressure sensor 280 can function as a built-in diagnostic and/or engine health monitoring system. Any significant fluctuations in the measured pressure that are outside of a predetermined limit may provide advanced warning of other problems with the engine 220. The engine 220 can be configured to provide a notice or indication to an operator when any measured pressures are outside of a predetermined operational envelope.

Yet another feature of the engine 220 is that the peak crankcase pressure may be used as a fall-back fuel metering scheme in the event the throttle position sensor fails. In one embodiment, for example, the throttle servo pulse width may be used to infer the throttle position in the event the throttle position sensor fails. More specifically, in an aircraft in which the engine 220 is installed (e.g., the aircraft 100 of FIG. 1), the throttle is controlled by, among other things, a servo, a motor, and associated electronics (shown collectively as servo 153 in FIG. 4D) that convert a particular electronic pulse width to a particular angular position. Because of the fixed input-to-output transfer function of the servo and the fixed geometry of the servo/throttle combination, there is a fixed relationship between the servo pulse width and the throttle's mechanical position. The electronic fuel injection (EFI) controller normally uses a very accurate position sensor to determine throttle angle, but in the event of a failure of the throttle position sensor, the servo pulse width can be used to infer a reasonably accurate estimate of the throttle angle.

FIG. 5 is a schematic illustration of a two-stroke fuel injected engine 320 configured in accordance with yet another embodiment of the disclosure. The engine 320 differs from the engines 120 and 220 described above in that the engine 320 comprises two cylinders 324 that share a common crankcase 332. More specifically, the engine 320 includes a first cylinder 324a having a first piston 326a coupled to a crankshaft 328, and a second cylinder 324b having a second piston 326b coupled to the crankshaft 328. The engine 320 can have a number of components generally similar to the engines 120 and 220 described above with reference to FIGS. 1-4D and can have many of the same features and advantages. For example, the engine 320 may also be configured to utilize the skip-cycle and/or peak pressure techniques described above as well as various other features described herein.

The first piston 326a and the first cylinder 324a together define a first variable volume combustion chamber 334a, and the second piston 326b and the second cylinder 324b together define a second variable volume combustion chamber 334b. A first transfer or scavenge passage 342a extends through the cylinder block 322 between the crankcase 332 and the first combustion chamber 334a, and a second transfer or scavenge passage 342b extends through the cylinder block 322 between the crankcase 332 and the second combustion chamber 334b. The first transfer passage 342a includes a first transfer or boost port 346a, and the second transfer passage 342b includes a second transfer or boost port 346b. The first and second transfer ports 346a and 346b are positioned to be opened and closed as the corresponding first and second pistons 326a and 326b reciprocably move within the engine 320. More specifically, the first and second transfer ports 346a and 346b each include a first end in communication with the crankcase 332 and a second end spaced apart from the first end and positioned to be opened and closed relative to the corresponding combustion chamber as the first and second pistons 326a and 326b slidably move within the respect cylinders.

The engine 320 includes an air induction system comprising an air intake track or passage 336 having an inlet portion 338 in fluid communication with crankcase 332. One or more reed type or rotary check valves 340 are positioned at the inlet portion 338 of the air intake passage 336. Exhaust passages 348 are in communication with the first and second combustion chambers 324a and 324b and configured to exhaust gases to the atmosphere. The engine 320 also includes one or more ignition sources (e.g., spark plugs) 349 configured to fire a charge in the first and second combustion chambers 334a and 334b.

In many conventional multi-cylinder engines that share a common crankcase, fuel is injected directly into the crankcase. One problem with this arrangement, however, is that the rotational movement of the crankshaft throws more fuel/air mixture toward one cylinder than the other. This unbalanced distribution causes the engine to operate inefficiently and can result in uneven or unbalanced power output from the engine. One feature of the engine 320, however, is that fuel is injected at or proximate to the transfer or boost ports 346a and 346b rather than into the crankcase 332. More specifically, the first and second pistons 326a and 326b each include one or more openings or apertures 360 extending through the skirt portions of each piston. The engine 320 includes fuel injectors 350 positioned at least proximate to the respective transfer ports 346a and 346b and configured to inject or supply fuel (as shown by arrows A) through the opening(s) 360 in the skirt portions of each piston 326a and 326b and into the respective combustion chambers 334a and 334b. In other embodiments, however, the skirt portions of each piston 326a and 326b may not have opening(s) 360. In these embodiments, the fuel injectors 350 may still be positioned to inject or supply fuel at or proximate to the transfer ports 346a and 346b of the engine 220 to the bottom of each piston 326a and 326b.

This arrangement is expected to significantly reduce or eliminate the problems associated with unbalanced distribution. For example, one advantage of this arrangement is that each combustion chamber 334a and 334b can receive the “ideal,” generally balanced fuel/air mixture during operation. Thus, the engine 320 can consistently provide the desired power output and operate more efficiently than conventional multi-cylinder engines. In other embodiments, the fuel injectors 350 can have a different arrangement and/or be positioned at a different point relative to the pistons 326a and 326b. In addition, although the engine 320 has two cylinders 324a and 324b, it will be appreciated that the engine 320 may have more than two cylinders.

One additional feature of the engine 320 is that the engine is expected to provide improved fuel evaporation performance as compared with conventional engines. For example, fuel (e.g., heavy fuel) injected into the engine 320 is injected or squirted onto the bottom of a hot piston, thus improving or enhancing evaporation of such fuel. Further, this arrangement is also expected to provide a cooling effect on the piston during operation.

In other embodiments, many of the arrangement/techniques described above could be used with a single cylinder engine. For example, the “under piston” injection described above with reference to FIG. 5 that injects or shoots fuel through the piston skirt onto the bottom of the piston as described above could also provide useful piston cooling in single cylinder engines. In still further embodiments, the arrangements described above may also be used in engines have other configurations or features.

From the foregoing, it will be appreciated that specific embodiments of the disclosure have been described herein for purposes of illustration, but that various modifications can be made without deviating from the spirit and scope of the disclosure. For example, the engines and associated components described above with reference to FIGS. 1-5 may have a different configuration and/or include different features. Moreover, specific elements of any of the foregoing embodiments can be combined or substituted for elements in other embodiments. For example, the two-stroke fuel injected engines described in the context of specific aircraft systems can be implemented in a number of other aircraft or non-aircraft systems that include two-stroke engines. Certain aspects of the disclosure are accordingly not limited to aircraft systems.

Specific elements of any of the foregoing embodiments can be combined or substituted for elements in other embodiments. For example, as noted previously, engines configured in accordance with this disclosure may include only one of the foregoing features described above with reference to FIGS. 1-5, or may include two or more of the features in combination. Furthermore, while advantages associated with certain embodiments of the disclosure have been described in the context of these embodiments, other embodiments may also exhibit such advantages, and not all embodiments need necessarily exhibit such advantages to fall within the scope of the disclosure. Accordingly, embodiments of the disclosure are not limited except as by the appended claims.

I/We claim:

1. An aircraft system, comprising:
a two-stroke, fuel injected internal combustion engine carried by an unmanned aircraft, the two-stroke, fuel injected engine including
a cylinder;
a crankcase in communication with and extending from the cylinder;
a piston in the cylinder and operably coupled to a crankshaft in the crankcase, wherein the piston and the cylinder define, at least in part, a variable volume combustion chamber;
a transfer passage extending between the crankcase and the combustion chamber, wherein the transfer passage has a first end in communication with the crankcase and a second end spaced apart from the first end and positioned to be opened and closed relative to the combustion chamber as the piston slidably moves within the cylinder between a top dead center position and a bottom dead center position;
a fuel injector positioned for injection of fuel to at least one of the crankcase and the cylinder;
a controller operably coupled to the fuel injector and configured to control operation of the fuel injector, wherein the controller is configured to vary an injection event of the fuel injector such that the injection event occurs every nth compression cycle of the engine; and
a pressure sensor in communication with the crankcase and configured to measure a peak pressure in the crankcase, and wherein the controller is configured to modify one or more parameters of the injection event in response to the measured peak pressure.

2. The aircraft system of claim 1 wherein the cylinder is a first cylinder, the piston is a first piston having a first piston skirt including one or more first openings extending completely through the first piston skirt, and the transfer passage is a first transfer passage, and wherein the engine further comprises:
a second cylinder opposite the first cylinder and in communication with the crankcase;
a second piston in the second cylinder and operably coupled to the crankshaft, wherein the second piston and the second cylinder define, at least in part, a second variable volume combustion chamber; and
a second transfer passage extending between the crankcase and the second combustion chamber,
wherein the fuel injector is positioned at least proximate to the second end of the first transfer passage to supply fuel through the first openings in the first piston skirt.

3. The aircraft system of claim 2 wherein the fuel injector is a first fuel injector, and wherein:
the second transfer passage has a first end in communication with the crankcase and a second end spaced apart from the first end and positioned to be opened and closed relative to the second combustion chamber as the second piston slidably moves within the second cylinder between the top dead center position and the bottom dead center position;
the second piston comprises a second piston skirt including one or more openings extending completely through the second piston skirt; and
the second fuel injector is positioned at least proximate to the second end of the second transfer passage to supply fuel through the second openings in the second piston skirt.

4. The aircraft system of claim 1 wherein the engine is a heavy fuel engine (HFE) configured to use kerosene-based heavy fuels.

5. The aircraft system of claim 1 wherein the engine is a gasoline powered engine.

6. The aircraft system of claim 1 wherein the injection event occurs every second compression cycle.

7. The aircraft system of claim 1 wherein the injection event occurs every third compression cycle.

8. The aircraft system of claim 1 wherein the injection event is synchronous with the engine cycle.

9. The aircraft system of claim 1 wherein the injection event is non-synchronous with the engine cycle.

10. The aircraft system of claim 1 wherein the fuel injector is positioned for direct injection of fuel into the crankcase.

11. The aircraft system of claim 1 wherein the fuel injector is positioned for injection of fuel to an intake track in fluid communication with the crankcase, and wherein the engine further comprises a solenoid valve between the intake track and the crankcase, wherein the solenoid valve is configured to control a flow rate of fuel from the intake track into the crankcase.

12. The aircraft system of claim 1 wherein the controller is configured to vary the injection event based, at least in part, on a map schedule stored in non-volatile memory of the controller.

13. The aircraft system of claim 12 wherein the controller is further configured to vary the injection event based on one or more of the following: temperature, crankcase pressure, throttle position, and crank timing.

14. The aircraft system of claim 1 wherein the engine is configured to operate using speed density control mode.

15. The aircraft system of claim 1, further comprising a throttle operably coupled to the engine, wherein the throttle is controlled, at least in part, by a servo and a servo controller operably coupled to the servo and configured to convert a servo pulse width to a particular angular position of the throttle.

16. The aircraft system of claim 15 wherein the servo pulse width is configured to be used as a secondary or backup input to infer the throttle position in the event of throttle position sensor failure.

17. A fuel injected, two-stroke internal combustion engine, comprising:
a cylinder block having a cylinder formed therein;
a crankcase in fluid communication with the cylinder;
a piston slidably housed in the cylinder and operably coupled to a crankshaft in the crankcase, wherein the piston and the cylinder define, at least in part, a variable volume combustion chamber;
a fuel injector positioned to supply fuel to at least one of the crankcase and the cylinder;
a pressure sensor in communication with the crankcase and configured to measure a peak pressure in the crankcase; and
a fuel injection system controller operably coupled to the fuel injector and configured to control operation of the fuel-injector,
wherein the fuel injection system controller is configured to vary an injection event of the fuel injector such that the injection event occurs every nth compression cycle of the engine, wherein n is 2 or a number greater than 2, and
wherein the fuel injection system controller is configured to modify one or more parameters of the injection event in response to the measured peak pressure.

18. The engine of claim 17 wherein the engine is a heavy fuel engine (HFE) configured to use kerosene-based heavy fuels.

19. The engine of claim 17 wherein the injection event occurs every second compression cycle.

20. The engine of claim 17 wherein the cylinder is a first cylinder, the piston is a first piston comprising a first piston skirt and one or more first apertures extending completely through the piston skirt, the combustion chamber is a first combustion chamber, and the fuel injector is a first fuel injector, and wherein the engine further comprises:
a first transfer passage extending through the cylinder block between the crankcase and the first combustion chamber, wherein the first transfer passage has a first end in communication with the crankcase and a second end spaced apart from the first end and positioned to be opened and closed relative to the first combustion chamber as the first piston reciprocably moves within the first cylinder;
a second cylinder opposite the first cylinder and in fluid communication with the crankcase;
a second piston slidably housed in the second cylinder and operably coupled to the crankshaft in the crankcase, wherein the second piston and the second cylinder define, at least in part, a second variable volume combustion chamber, and wherein the second piston comprises a second piston skirt and one or more second apertures extending completely through the second piston skirt; and
a second transfer passage extending through the cylinder block between the crankcase and the second combustion chamber, wherein the second transfer passage has a first end in communication with the crankcase and a second end spaced apart from the first end and positioned to be opened and closed relative to the second combustion chamber as the second piston reciprocably moves within the second cylinder,
wherein the first fuel injector is positioned adjacent to the second end of the first transfer passage to supply fuel directly to the first combustion chamber through the one or more first apertures in the first piston skirt,
wherein the second fuel injector is positioned adjacent to the second end of the second transfer passage to supply fuel directly to the second combustion chamber through the one or more second apertures in the second piston skirt.

21. The engine of claim 17 wherein the fuel injection system controller is configured to vary the injection event based, at least in part, on a map schedule stored in non-volatile memory of the fuel injection system controller, and one or more of the following sensed engine parameters: temperature, crankcase pressure, throttle position, and crank timing.

22. An unmanned aircraft, comprising:
a fuselage;
a propeller carried by the fuselage;
a two-stroke, fuel injected heavy fuel engine (HFE) carried by the fuselage and operably coupled to the propeller, wherein the HFE comprises
a cylinder;
a crankcase in fluid communication with and extending from the cylinder;
a piston slidably housed in the cylinder and operably coupled to a crankshaft, wherein the piston and the cylinder define, at least in part, a variable volume combustion chamber;
a scavenge passage extending between the crankcase and the combustion chamber, wherein the scavenge passage has a first end in communication with the crankcase and a second end positioned to be opened and closed relative to the combustion chamber as the piston reciprocably moves within the cylinder;
a fuel injector positioned for injection of kerosene-based heavy fuel to at least one of the crankcase and the cylinder;
a pressure sensor in communication with the crankcase and configured to measure a peak pressure in the crankcase; and
a fuel injection controller operably coupled to the fuel injector and configured to control operation of the fuel injector,
wherein the fuel injection controller is configured to (a) modify one or more parameters of the injection event in response to the measured peak pressure, and (b) vary an injection event of the fuel injector such that the injection event occurs every nth compression cycle of the engine.

23. The unmanned aircraft of claim 22 wherein the engine is configured to utilize speed density control mode.

24. The unmanned aircraft of claim 22 wherein the fuel injection controller is configured to use the sensed peak pressure as a primary input for modifying the injection event.

25. The unmanned aircraft of claim 22 wherein the fuel injection controller is further configured to use a throttle position sensor input as a primary input for modifying the injection event, and wherein the fuel injection controller is configured to use the sensed peak pressure as a secondary or backup input for modifying the injection event.
